(19) United States
(12) Patent Application Publication
(10) Pub. No.: US 2004/0059687 A1
(43) Pub. Date: Mar. 25, 2004

(54) Providing a verifiable delivery payment coding

(76) Inventor: Vantresa Stickler, Annapolis, MD (US)

Correspondence Address: Finnegan, Henderson, Farabow,, Garrett & Dunner, L.L.P., 1300 I Street, N.W., Washington, DC, 20005-3315, US

(21) Appl. No.: 10/630,708

(22) Filed: Jul. 31, 2003

Related U.S. Application Data
(60) Provisional application No. 60/407,372, filed on Aug. 29, 2002.

(51) Int. Cl. G06F 17/60

(52) U.S. Cl. 705/75

(57) ABSTRACT

Providing a verifiable delivery payment coding comprises providing verification data configured to be included in a delivery payment coding. Next, providing the verifiable delivery payment coding comprises receiving an item in an item delivery system, the item comprising the delivery payment coding including the verification data. In addition, providing the verifiable delivery payment coding comprises verifying the authenticity of the delivery payment coding using the verification data included in the delivery payment coding.

### RELATED APPLICATIONS

Under provisions of 35 U.S.C. § 119(e), Applicant claims the benefit of U.S. provisional application No. 60/407,372, filed Aug. 29, 2002, which is incorporated herein by reference.

### TECHNICAL FIELD

The present invention relates to the field of providing delivery payment coding. More particularly, the present invention, in various specific embodiments, involves methods and systems for providing a verifiable delivery payment coding.

### BACKGROUND

The United States Postal Service (USPS) is an independent government agency that provides mail delivery and other services to the public.

The USPS is widely recognized as a safe and reliable means for sending and receiving mail and other items. With the advent and steady growth of electronic mail and electronic commerce, the physical mail stream will increasingly be utilized for sending and receiving packages. In the context of electronic commerce, a consumer of item delivery services may desire, for example, to remotely purchase postage for the item over the Internet.

Therefore, the need to efficiently provide postage remotely has that may be authenticated by a delivery system operator has become a critical service for many delivery system operators. This is because in an increasingly competitive environment, meeting and exceeding the expectations of those who receive a service is essential for a service provider.

One solution, for example, to the remote delivery payment coding problem is for the item delivery system operator to license a third party, unaffiliated with the item delivery system operator, to provide consumers postage electronically. In this situation, the third party registers the consumer and charges a fee for the service.

Great inefficiencies are created in this procedure because, for example, verifying the authenticity of the delivery payment coding may not be possible with third party systems. Accordingly, efficiently providing a verifiable delivery payment coding remains an elusive goal. Thus, there remains a need for efficiently providing delivery payment codings. In addition, there remains a need for efficiently providing delivery payment codings that can be verified or authenticated.

### SUMMARY OF THE INVENTION

In accordance with the current invention, a verifiable delivery payment coding method and system are provided that avoid the problems associated with prior delivery payment coding methods and systems as discussed herein above.

In one aspect, a method for providing a verifiable delivery payment coding comprises providing verification data configured to be included in a delivery payment coding, receiving an item in an item delivery system, the item comprising the delivery payment coding including the verification data, and verifying the authenticity of the delivery payment coding using the verification data included in the delivery payment coding.

In another aspect, a system for providing a verifiable delivery payment coding comprises a component for providing verification data configured to be included in a delivery payment coding, a component for receiving an item in an item delivery system, the item comprising the delivery payment coding including the verification data, and a component for verifying the authenticity of the delivery payment coding using the verification data included in the delivery payment coding.

In yet another aspect, a computer-readable medium on which is stored a set of instructions for providing a verifiable delivery payment coding, which when executed perform stages comprising providing verification data configured to be included in a delivery payment coding, receiving an item in an item delivery system, the item comprising the delivery payment coding including the verification data, and verifying the authenticity of the delivery payment coding using the verification data included in the delivery payment coding.

In yet another aspect, a system for providing a verifiable delivery payment coding comprises a means for providing verification data configured to be included in a delivery payment coding, a means for receiving an item in an item delivery system, the item comprising the delivery payment coding including the verification data, and a means for verifying the authenticity of the delivery payment coding using the verification data included in the delivery payment coding.

Both the foregoing general description and the following detailed description are exemplary and are intended to provide further explanation of the invention as claimed.

### BRIEF DESCRIPTION OF THE DRAWINGS

The accompanying drawings provide a further understanding of the invention and, together with the detailed description, explain the principles of the invention. In the drawings:

FIG. 1 is a functional block diagram of an exemplary item delivery system including an exemplary system for providing a verifiable delivery payment coding consistent with an embodiment of the present invention;

FIG. 2 is a functional block diagram of an exemplary system for providing a verifiable delivery payment coding consistent with an embodiment of the present invention;

FIG. 3 is a functional block diagram of an exemplary system for providing a verifiable delivery payment coding consistent with an embodiment of present invention;

FIG. 4 is a flow chart of an exemplary method for providing a verifiable delivery payment coding consistent with an embodiment of the present invention; and

FIG. 5 is a flow chart of an exemplary subroutine used in the exemplary method of FIG. 4 for verifying the authenticity of the delivery payment coding consistent with an embodiment of the present invention.

### DETAILED DESCRIPTION

Reference will now be made to various embodiments according to this invention, examples of which are shown in the accompanying drawings and will be obvious from the description of the invention. In the drawings, the same reference numbers represent the same or similar elements in the different drawings whenever possible.

Consistent with an embodiment of the present invention, a system for providing a verifiable delivery payment coding may comprise a component for providing verification data configured to be included in a delivery payment coding, a component for receiving an item in an item delivery system, the item comprising the delivery payment coding including the verification data, and a component for verifying the authenticity of the delivery payment coding using the verification data included in the delivery payment coding. In addition, the system may include a component for receiving a request for the verification data, a component for receiving a payment for delivery of the item, a component for delivering the item to a recipient, and a component for confirming the item delivery using the verification data from the delivery payment coding.

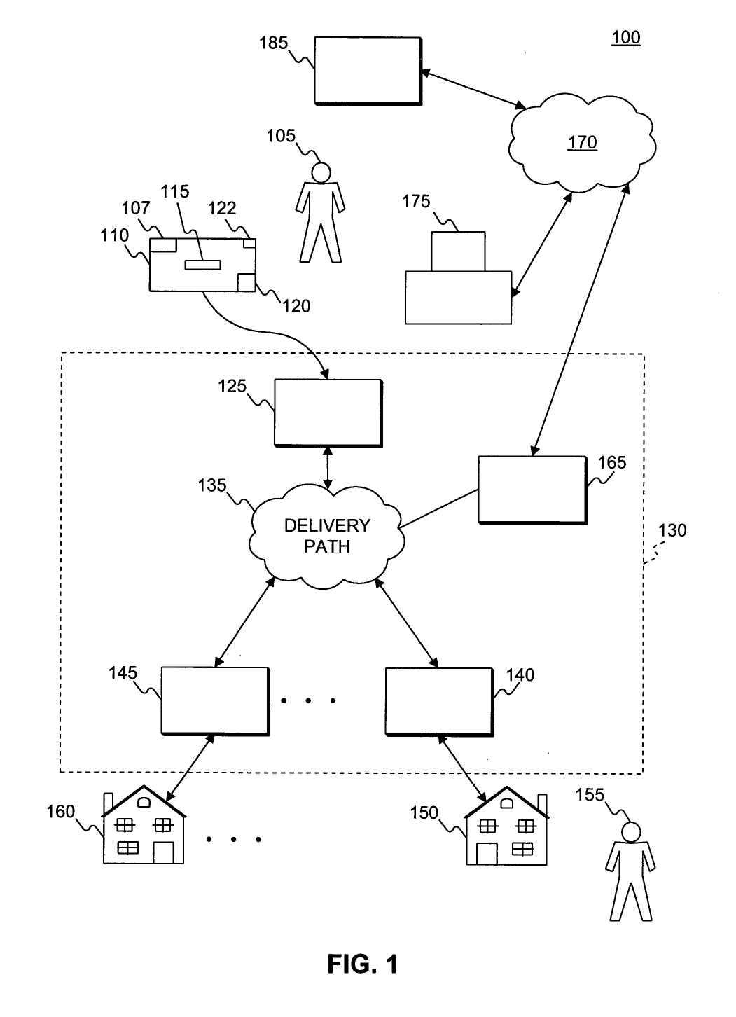

Consistent with an embodiment of the present invention and referring to FIG. 1, the aforementioned components are included in a mailing system 100 which may comprise a payment coding system 185 used in conjunction with a delivery system 130 and a user device 175. The aforementioned devices and systems are exemplary and other devices and systems may comprise the aforementioned components and still be consistent with embodiment of the present invention. In addition, payment coding system 185 may be operated by an item delivery system operator or other entities or enterprises, for example.

Mailing system 100 is shown in FIG. 1. For example, a sender 105 may place an item 110 into delivery system 130. Item 110 may contain a label 115 indicating a first address 150 of a recipient 155 and a return address 107 indicating where to return item 110 if necessary. Item 110 may also contain a tracking indicia 120 relating sender 105 and recipient 155. Tracking indicia 120 may be placed on item 110 by sender 105 or the delivery system operator. In addition, item 110 may include a delivery payment coding 122 that will be described in greater detail below. Elements of and data contained in return address 107, label 115, tracking indicia 120, and delivery payment coding 122 may be included together as one element or label, for example, on item 110.

Item 110 may be routed through delivery system 130, which may comprise a sender plant 125, a delivery path 135, a first address plant 140, an alternative address plant 145, and an alternative processing point 165. Delivery path 135 may comprise a plurality of plants similar to sender plant 125, first address plant 140, and alternative address plant 145. The plants within delivery path 135 may contain, among other things, automated systems and sorting equipment and are designed to receive and process a plurality of items. Delivery system 130 may be configured to sense tracking indicia 120 or delivery payment coding 122 placed on item 110 as it passes through the elements of delivery system 130 directing the movement of item 110 through delivery system 130. In addition to facilitating the tracking of item 110 through delivery system 130, tracking indicia 120 and delivery payment coding 122 may identify a sales transaction and relate recipient 155 and sender 105.

Item 110 may comprise at least one of a mailpiece, a United States Postal Service Priority Mail package, a United States Postal Service Express Mail Package, a United States Postal Service Global Express Mail Package, or a United States Postal Service Global Express Guarantee Package. Moreover, item delivery system 130 a comprise elements of the United States Postal Service.

Tracking indicia 120 and delivery payment coding 122 may comprise a bar code or a PLANET code, for example, but may also comprise any machine-readable or optically-scanable element. A bar code is a code used for recognition by a bar code scanner (reader). Traditional one-dimensional bar codes use the bar's width to encode a product or account number. Two-dimensional bar codes, such as PDF417, MAXICODE and DATAMATRIX, are scanned horizontally and vertically and hold considerably more data. Generally, PDF417 is widely used for general purposes, MAXICODE is used for high-speed sorting, and DATAMATRIX is used for marking small parts.

Historically, system operators sorted flat mail using POSTNET, a 12-digit barcode consisting of alternating long and short bars indicating the destination of, for example, a mailpiece. Responding to the expanding needs of users, particularly heavy volume users, PLANET code was developed on the foundation of the existing technical infrastructure. The PLANET Code is the “opposite” of the current POSTNET codes, that is, reversing long bars for short and short bars for long. This innovation offers the convenience of a bar code that is easily applied using current bar-coding methods, and is readily scanned by the high-speed automation equipment already located in the plurality of plants comprising delivery system 130.

Item 110 may be sent through delivery system 130 by sender 105 to first address plant 140. At anytime in the delivery process a determination may be made as to whether item 110 is undeliverable. If it is determined that item 110 is undeliverable, item 110 may be forwarded to alternative processing point 165 where an ancillary service may be performed. Examples of such ancillary services are recycle service (treating item 110 as waste), NIXIE service, and Computerized Forwarding Service (CFS).

With respect to NIXIE service, NIXIE is a classification given to an item that cannot be sorted or is undeliverable-as-addressed because of an incorrect, illegible, or insufficient delivery address. If item 110 is undeliverableas-addressed, address correction service (re-label with a correct address) or return service (return item to the sender) may be performed. In this case, a NIXIE operator specialized in the handling of such items is required. If item 110 requires return service, return address 107 on item 110 is read and item 110 is sent to return address 107 accordingly. Return address 107 is an element of item 110 that is usually placed in the upper left corner of item 110 to indicate the address of sender 105. This address indicates where sender 105 wants item 110 returned if it is undeliverable. In addition return address 107 may indicate where sender 105 will receive a bill for any fees due for the return of item 110.

When item 110 requires address correction service, a NIXIE operator obtains the proper address of recipient 155 or the reason for non-delivery. While NIXIE processing may comprise address correction service or return service, those skilled in the art will appreciate that may other types of NIXIE processing may be performed.

Computerized forwarding service is a centralized, computerized address label-generating operation that forwards undeliverable-as-addressed items to recipients. In this case, recipient 155 may pre-register an alternative address 160 of recipient 155 with the delivery system operator in order to have all items forwarded to alternative address 160. For example, if recipient 155 moves and wishes to have items sent to alternative address 160, recipient 155 notifies the delivery system operator of alternative address 160. Once the delivery system operator is notified of alternative address 160, all items sent to first address 150 are detected by delivery system 130, re-labeled, and then forwarded to alternative address 160. In the aforementioned computerized forwarding service, items are forwarded only for a specific period of time. The delivery system operator expects recipient 155 to contact each and every sender who recipient 155 may expect to receive an item and notify the possible senders of the address change of recipient 155. After the computerized forwarding service time period is complete, the delivery system operator will cease forwarding items to recipient 155 and will return to the sender 105 all items sent to first address 150.

If ancillary services were required, item 110 may remain at alternative processing point 165 or may be processed at an item recovery section of alternative processing point 165. Item 110 may be recovered by sender 105 or recipient 155 upon the completion of a tracer. A tracer is a form completed by sender 105 or recipient 155 to locate delayed or undelivered items. While item recovery may occur at alternative processing point 165, those skilled in the art will appreciate that may other types of processing may be performed at alternative processing point 165.

While payment coding system 185 is shown to be separate from delivery system 130, the functionality of payment coding system 185 may be performed under the control of the delivery system operator at alternative processing point 165, at any point within delivery system 130, or at any point outside delivery system 130. Moreover, the functionality of payment coding system 185 may be performed by an enterprise not under the control of the delivery system operator.

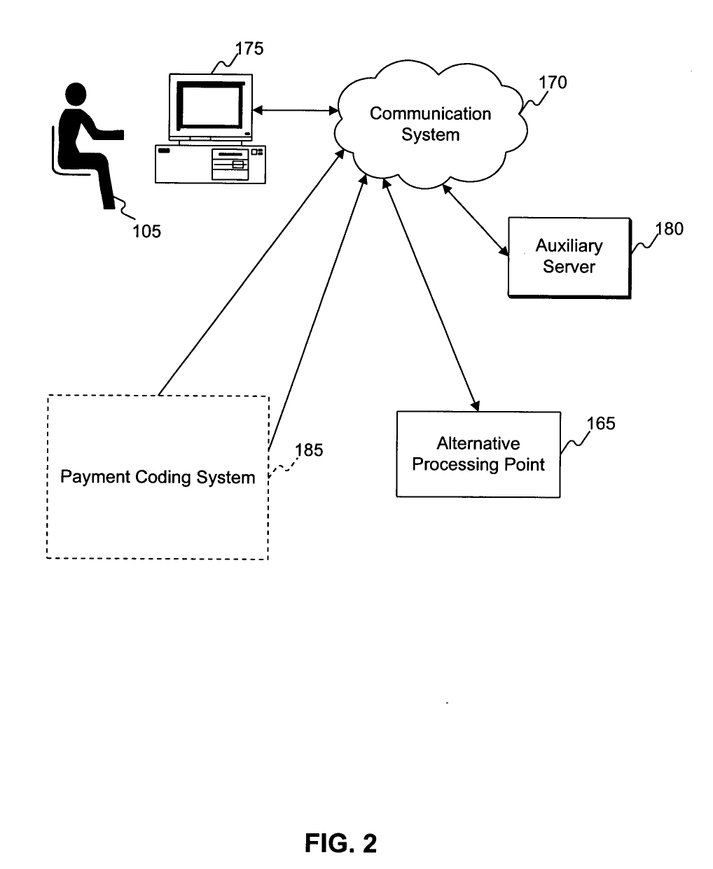

As herein embodied and illustrated in FIG. 2, elements of system 100 comprising user device 175, communication system 170, and payment coding system 185 will be described in greater detail. User device 175 may comprise a personal computer or other similar microcomputer-based workstation. It can be appreciated, however, that user device 175 may comprise any type of computer operating environment such as hand-held devices, multiprocessor systems, microprocessor-based or programmable sender electronics, minicomputers, mainframe computers, and the like. User device 175 may also be practiced in distributed computing environments where tasks are performed by remote processing devices. Furthermore, user device 175 may comprise a mobile terminal such as a smart phone, a cellular telephone, a cellular telephone utilizing wireless application protocol (WAP), personal digital assistant (PDA), intelligent pager, portable computer, a hand held computer, a conventional telephone, or a facsimile machine. The aforementioned systems and devices are exemplary and user device 175 may comprise other systems or devices.

A PDA is a handheld computer that serves as an organizer for personal information. It generally includes at least a name and address database, to-do list and note taker. PDAs are typically pen-based and use a stylus (“pen”) to tap selections on menus and to enter printed characters. The unit may also include a small on-screen keyboard which is tapped with the pen. Data may be synchronized between the PDA and a desktop computer through a cable or wireless transmissions.

WAP is a standard for providing cellular phones, pagers and other handheld devices with secure access to e-mail and text-based Web pages. It provides a complete environment for wireless applications that includes a wireless counterpart of TCP/IP and a framework for telephony integration such as call control and phone book access. Wireless Markup Language (WML), which is a streamlined version of HTML for small screen displays, is featured in WAP. WAP uses WMLScript, a compact language that runs in limited memory, and supports handheld input methods such as keypads and voice recognition. In addition, WAP is independent of the air interface and runs over all the major wireless networks. Moreover, it is also device independent, requiring only a minimum functionality in the unit so that it can be used with many different phones and handheld devices.

User device 175 may be located in a home, office, store, an item delivery counter within a store, a retail center kiosk, an item delivery system office, or any location wherein it may be operated. Moreover, user device 175 may be operated by sender 105 that may comprise a subject, a technician, an advisor, a sales consultant, a sales person, or any other person. It can be appreciated that user device 175 may be located at a variety of places and operated by a variety of people.

Communication system 170 may comprise, for example, a local area network (LAN) or a wide area network (WAN). Such networking environments are commonplace in offices, enterprise-wide computer networks, intranets, and the Internet, and are known by those skilled in the art. When a LAN is used as communication system 170, user device 175 and elements of payment coding system 185 may be connected to communication system 170 through a network interface located at each of the respective user device 175 and elements of payment coding system 185. When a WAN networking environment is utilized as communication system 170, user device 175 and elements of payment coding system 185 typically include an internal or external modem (not shown) or other means for establishing communications over the WAN, such as the Internet.

In addition to utilizing a wire line communications system as communication system 170, a wireless communications system, or a combination of wire line and wireless may be utilized as communication system 170 in order to, for example, exchange web pages via the internet, exchange e-mails via the Internet, or for utilizing other communications channels. Wireless can be defined as radio transmission via the airwaves, however, those skilled in the art will appreciate that various other communication techniques can be used to provide wireless transmission including infrared line of sight, cellular, microwave, satellite, packet radio and spread spectrum radio. User device 175 and elements of payment coding system 185 in the wireless environment can be any mobile terminal such as a cellular phone, personal digital assistant (PDA), intelligent pager, portable computer, hand held computer, or any device capable of receiving wireless data. Wireless data may include, but is not limited to, paging, text messaging, e-mail, Internet access and other specialized data applications specifically excluding or including voice transmission.

In utilizing communication system 170, data sent over communication system 170 may be encrypted to insure data security. When encrypting, the data may be converted into a secret code for transmission over a public network. The original file, or “plaintext,” may be converted into a coded equivalent called “ciphertext” via an encryption algorithm executed, for example, on user device 175 or on elements of payment coding system 185. The ciphertext is decoded (decrypted) at a receiving end and turned back into plaintext.

The encryption algorithm may use a key, which is a binary number that is typically from 40 to 128 bits in length. The greater the number of bits in the key (cipher strength), the more possible key combinations and the longer it would take to break the code. The data is encrypted, or “locked,” by combining the bits in the key mathematically with the data bits. At the receiving end, the key is used to “unlock” the code and restore the original data.

There are two main cryptographic methods that may be suitable for use with system 100. The traditional method uses a secret key, such as the Data Encryption Standard (DES). In DES, both sender and receiver use the same key to encrypt and decrypt. This is the fastest method, but transmitting the secret key to the recipient in the first place is not secure. The second method is publickey cryptography, such as the Rivest-Shamir-Adleman (RSA) highly-secure cryptography method by RSA Data Security, Inc., Redwood City, Calif., (www.rsa.com). RSA uses a two-part concept with both a private and a public key. The private key is kept by the owner; the public key is published. Each recipient has a private key that is kept secret and a public key that is published for everyone. The sender looks up the recipient's public key and uses it to encrypt the message. The recipient uses the private key to decrypt the message. Owners never have a need to transmit their private keys to anyone in order to have their messages decrypted, thus the private keys are not in transit and are not vulnerable.

Public key cryptography software marketed under the name Pretty Good Privacy (PGP) from Pretty Good Privacy, Inc., (PGP) of San Mateo, Calif., (www.pqp.com) may be utilized in this embodiment. PGP was developed by Phil Zimmermann, founder of the company, and it is based on the RSA cryptographic method. A version for personal, non-business use is available on various Internet hosts. While PGP may be used to encrypt data transmitted over communication system 170, those skilled in the art will appreciate that many other types of encryption algorithms, methods and schemes may be employed.

In system 100, data may be transmitted by methods and processes other than, or in combination with communication system 170. These methods and processes may include, but are not limited to, transferring data via, diskette, CD ROM, facsimile, conventional mail, an interactive voice response system (IVR), or via voice over a publicly switched telephone network. An IVR is an automated telephone answering system that responds with a voice menu and allows the user to make choices and enter information via the telephone keypad. IVR systems are widely used in call centers as well as a replacement for human switchboard operators. An IVR system may also integrate database access and fax response.

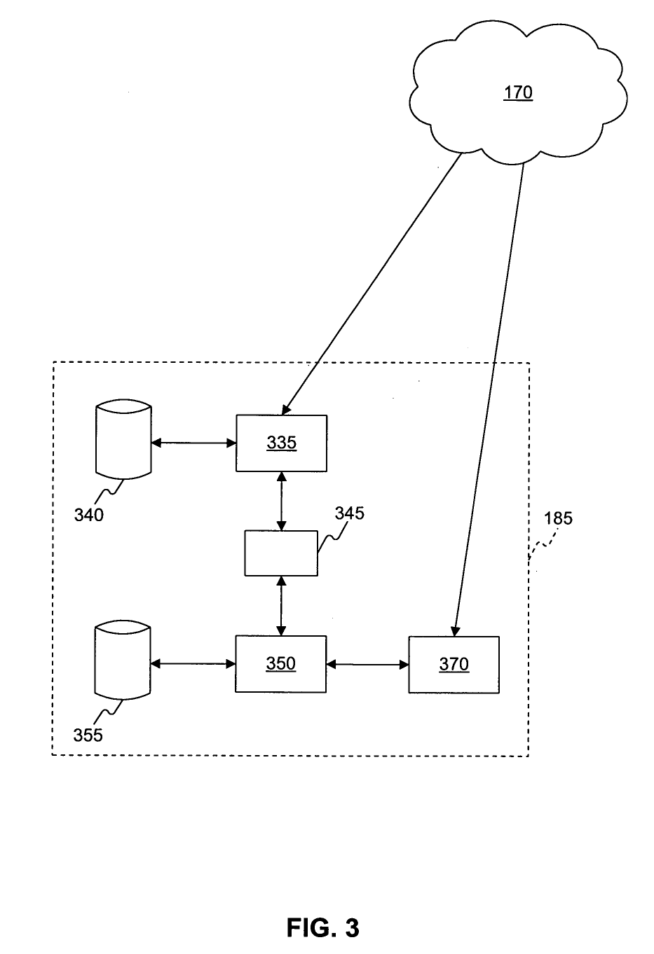

Referring to FIG. 3, exemplary payment coding system 185 may comprise a first server front end 335 with its associated first server front end database 340, a first server back end 350 with its associated first server back end database 355, and a simple mail transfer protocol (SMTP) server 370. Those skilled in the art will appreciate that this particular architecture of payment coding system 185 is exemplary, and that many other types of systems or architectures may be employed to implement payment coding system 185.

In exemplary payment coding system 185, first server front end 335 is separated from first server back end 350 by a first server firewall 345. One function of first server front end 335 is to provide an interface via communication system 170 between user device 175 and payment coding system 185. The function of the SMTP server 370 is to provide, for example, an e-mail interface via communication system 170 between user device 175 and payment coding system 185.

Simple mail transfer protocol is a standard e-mail protocol on the Internet. It is a TCP/IP protocol that defines the message format and the message transfer agent (MTA), which stores and forwards the mail. SMTP was originally designed for only ASCII text, but MIME and other encoding methods enable program and multimedia files to be attached to e-mail messages. SMTP servers route SMTP messages throughout the Internet to a mail server, such as a Post Office Protocol 3 (POP3) or an Internet Messaging Access Protocol (IMAP) server, which provides a message store for incoming mail.

Post Office Protocol 3 (POP3) servers, using the SMTP messaging protocol, are standard mail servers commonly used on the Internet. POP3 servers provide a message store that holds incoming e-mail until users log on and download them. With POP3, all pending messages and attachments are downloaded at the same time. Internet Messaging Access Protocol (IMAP) is also a standard mail server that is widely used on the Internet. It provides a message store that holds incoming e-mail until users log on and download them. IMAP, however, is more sophisticated than the POP3 mail server. In IMAP, messages can be archived in folders, mailboxes can be shared, and a user can access multiple mail servers. There is also better integration with MIME, which is used to attach files. For example, users can read only the headers in the message without having to automatically accept and wait for unwanted attached files to download.

First server front end 335 and first server back end 350 may comprise a personal computer or other similar microcomputer-based workstations. Those skilled in the art, however, will appreciate that first server front end 335 and first server back end 350 may comprise any type of computer operating environment such as hand-held devices, multiprocessor systems, microprocessor-based or programmable sender electronics, minicomputers, mainframe computers, and the like. First server front end 335 and first Server back end 350 may also be practiced in distributed computing environments where tasks are performed by remote processing devices. Specifically, embodiments of first server front end 335 may utilize a COMPAQ PROLIANT 1600 server running WINDOWS 2000 and DOMINO Webserver. Similarly, first server back end 350 may be implemented on a COMPAQ PROLIANT 1600 server running NT4 and DOMINO Application Server. SMTP server 370 may be implemented on a COMPAQ DL 360 running WINDOWS 2000 and DOMINO SMTP Mail Server.

Other servers, such as an auxiliary server 180 shown in FIG. 2, may be included in system 100. Other servers used in system 100 may be constructed in an architecture similar to payment coding system 185 or may be constructed using other suitable architectures as are known by those skilled in the art.

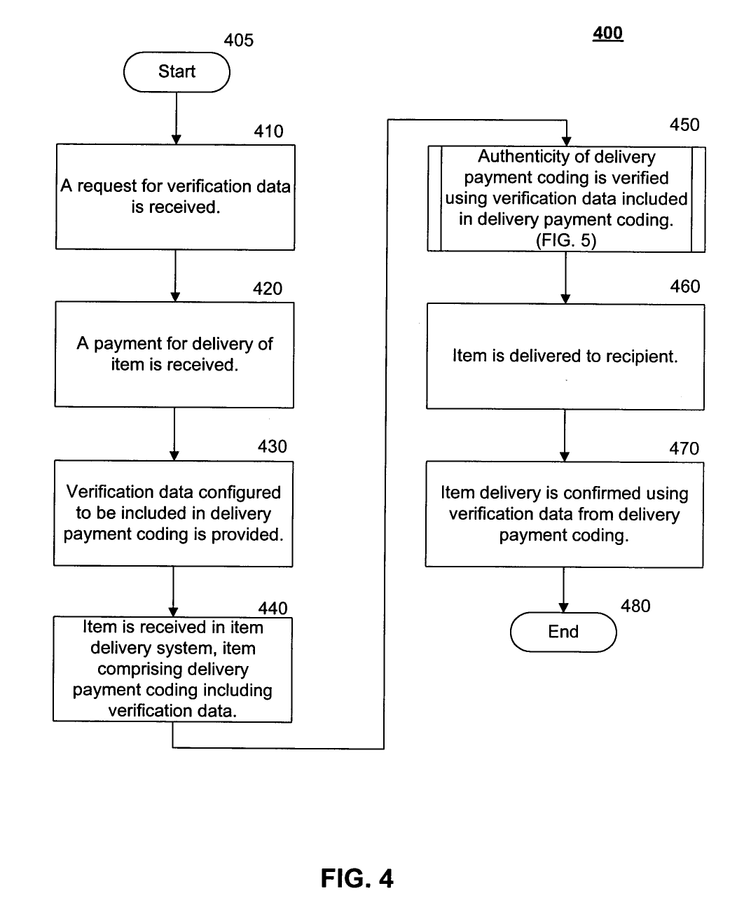

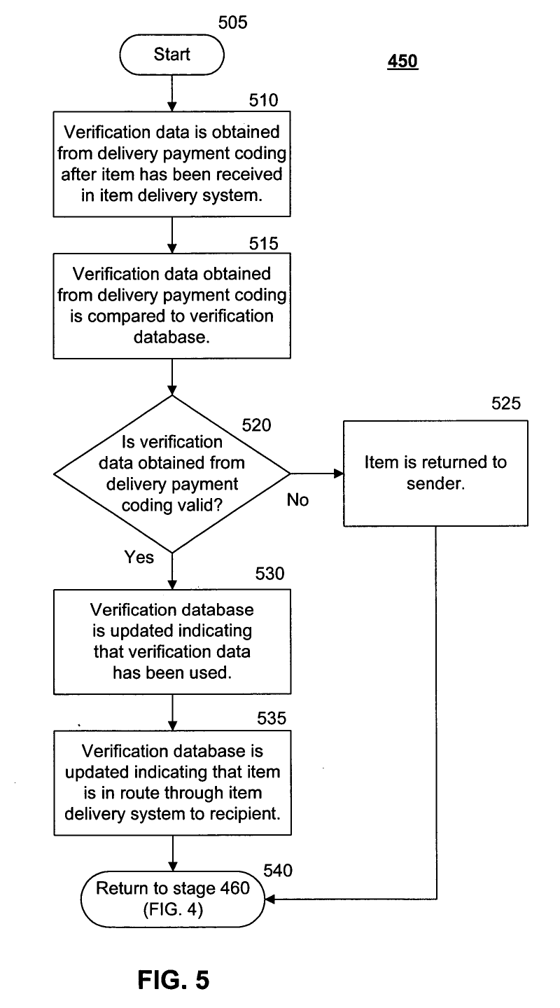

FIG. 4 is a flow chart setting forth the general stages involved in exemplary method 400 for providing a delivery payment coding. The implementation of the stages of exemplary method 400 in accordance with an exemplary embodiment of the present invention will be described in greater detail in FIG. 5. Exemplary method 400 begins at starting block 405 and proceeds to stage 410 where a request for verification data is received. For example, sender 105 may wish to send item 110 to recipient 155 through item delivery system 130. In order to do so, item 110 may need to include delivery payment coding 122 that at least indicates that a proper delivery fee has been paid to the delivery system operator. In order to obtain delivery payment coding 122, sender 105, operating user device 175 in communications with payment coding system 185 over communication system 170 for example, may request a proper delivery payment coding from the item delivery system operator. Specifically, sender 105 may wish to obtain a verifiable delivery payment coding wherein the request may also include a request for verification data to be included in delivery payment coding 122.

From stage 410 where the request for verification data is received, exemplary method 400 continues to stage 420 where a payment for delivery of item 110 is received. For example, after the request, but before the verification data is received, the system operator may wish to received payment for delivery of item 110 in advance. This payment may be made utilizing at least one of sending a bill, debiting a checking account, debiting a credit card account, debiting a debit card account, or receiving cash. The aforementioned payment methods are exemplary and other payment methods may be utilized.

Once the payment for delivery of item is received in stage 420, exemplary method 400 advances to stage 430 where verification data configured to be included in delivery payment coding 122 is provided. For example, the item delivery system operator may provide a unique datum to user device 175 over communications system 170 in an encrypted format. The unique datum may also be stored in payment coding system 185 databases and linked to data identifying the identity of sender 105, recipient 155, and the payment amount received, for example.

After verification data configured to be included in delivery payment coding 122 is provided in stage 430, exemplary method 400 proceeds to stage 440 where item 110 is received in item delivery system 130, item 110 comprising delivery payment coding 122 including verification data. For example, sender 105 may cause user device 175 to produce delivery payment coding 122. Specifically, user device 175 may print a label including a bar code with an adhesive on the opposite side. The bar code could encode the verification data. Once printed, sender 105 may attached the adhesive side of delivery payment coding 122 to item 110. With the delivery payment coding 122 attached, sender 105 may place item 110 in sender plant 125. Delivery payment coding 122 may appear, for example, to be a postage stamp that also include a machine readable element that encodes the verification data.

From stage 440 where item 110 is received in item delivery system 130, exemplary method 400 continues to exemplary subroutine 450 where authenticity of delivery payment coding 122 is verified using verification data included in delivery payment coding 122. The stages of exemplary subroutine 450 are described in greater detail below with respect to FIG. 5.

Once authenticity of delivery payment coding 122 is verified using verification data included in delivery payment coding 122 in exemplary subroutine 450, exemplary method 400 advances to stage 460 where item 110 is delivered to recipient 155. For example, item 110 may be efficiently routed from plant to plant within item delivery system 130 until it is received at first address plant 140. From first address plant 140, item 110 may then be delivered to recipient 155. While item 110 routes through item delivery system 130, elements within item delivery system 130 may detect the verification data from payment delivery coding 122 on item 110 and update databases to indicate the time and location of item 110. In addition, for example, the indicated times and locations may also be reported to sender 105 and recipient 155 over communications system 170 in any manner in which they can receive information.

After item 110 is delivered to recipient 155 in stage 460, exemplary method 400 proceeds to stage 470 where item delivery is confirmed using verification data from delivery payment coding 122. For example, once item 110 is received by recipient 155, notification may be sent to sender 105 that item 110 has been received by recipient. Specifically, because the verification data is linked in databases to sender information, payment coding system 185 may send an message to sender 105 that item 110 has been received. This message may be sent in any manner in which payment coding system 185 can send a message and in any manner in which sender 105 can receive a message. From stage 470 where item delivery is confirmed using verification data from delivery payment coding 122, exemplary method 400 ends at stage 480.

FIG. 5 describes exemplary subroutine 450 from FIG. 4 for verifying the authenticity of delivery payment coding 122 using the verification data included in delivery payment coding 122. Exemplary subroutine 450 begins at starting block 505 and proceeds to stage 510 where verification data is obtained from delivery payment coding 122 after item 110 has been received in item delivery system 130. For example, elements of item deliver system may machine-read or otherwise optically scan delivery payment coding 122 to obtain the verification data.

From stage 510 where verification data is obtained from delivery payment coding 122 after item 110 has been received in item delivery system 130, exemplary subroutine 450 continues to stage 515 where verification data obtained from delivery payment coding 122 is compared to a verification database. For example, the verification database stored in payment coding system 185 may include data relative to delivery of item 110 indexed by the verification data. Specifically, using the verification data obtained from delivery payment coding 122, data relative to the delivery of 110 may be retrieved from the verification database.

Once verification data obtained from delivery payment coding 122 is compared to verification database in stage 515, exemplary subroutine 450 advances to decision block 520 where it is determined if verification data obtained from delivery payment coding 122 valid. For example, the verification data read from delivery payment coding 122 may not exist in the verification database, if so, the verification data may be invalid due to fraud. Furthermore, the payment received associated with delivery payment code 122 may not correspond to a proper payment given the size or weight, for example, of item 110. If so, the verification data may be declared invalid. Moreover, an amount of time for using delivery payment coding may have passed, thus making the verification data invalid.

From decision block 520, if it is determined that verification data obtained from delivery payment coding 122 is not valid, exemplary subroutine 450 advances to stage 525 where item 110 is returned to sender 105. For example, item 110 may be sent back to sender 105 through item delivery system 130, or may be disposed of in a manner described above with respect to ancillary services for undeliverable items.

If at decision block 520, however, it was determined that verification data obtained from delivery payment coding 122 is valid, exemplary subroutine 450 continues to stage 530 where verification database is updated indicating that verification data has been used. For example, once the unique datum comprising the verification data has been used in association with a received item, the delivery system operator may wish to no longer use this datum. Otherwise, more delivery payment codings may be produced with the same verification data that may be used to deliver a plurality of items when payment for only one item has been made.

After verification database is updated in stage 530, exemplary subroutine 450 proceeds to stage 535 where verification database is updated indicating that item 110 is in route through item delivery system 130 to recipient 155. For example, once item 110 is received in item delivery system 130, notification may be sent to sender 105 of this event. Specifically, because the verification data is linked in databases to sender 105 information, payment coding system 185 may send an message to sender that item 110 has been received in item delivery system 130. This message may be sent in any manner in which payment coding system 185 can send a message and in any manner in which sender 105 can receive a message. In a similar manner, a notification can be sent to recipient 155 that item 110 is currently in route. From stage 535 where verification database is updated or from stage 525 where item 110 is returned to sender 155, exemplary subroutine 450 continues to stage 540 and returns to stage 460 of FIG. 4.

It will be appreciated that a system in accordance with an embodiment of the invention can be constructed in whole or in part from special purpose hardware or a general purpose computer system, or any combination thereof. Any portion of such a system may be controlled by a suitable program. Any program may in whole or in part comprise part of or be stored on the system in a conventional manner, or it may in whole or in part be provided in to the system over a network or other mechanism for transferring information in a conventional manner. In addition, it will be appreciated that the system may be operated and/or otherwise controlled by means of information provided by an operator using operator input elements (not shown) which may be connected directly to the system or which may transfer the information to the system over a network or other mechanism for transferring information in a conventional manner.

The foregoing description has been limited to a specific embodiment of this invention. It will be apparent, however, that various variations and modifications may be made to the invention, with the attainment of some or all of the advantages of the invention. It is the object of the appended claims to cover these and such other variations and modifications as come within the true spirit and scope of the invention.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

We claim:

1. A method for providing a verifiable delivery payment coding, comprising:
transmitting verification data configured to be included in a delivery payment coding;
receiving an item in an item delivery system, the item comprising the delivery payment coding including the verification data; and
verifying the authenticity of the delivery payment coding using the verification data.

2. The method of claim 1, wherein the verification data included in the delivery payment coding is machine readable.

3. The method of claim 1, wherein the verification data included in the delivery payment coding is optically scanable.

4. The method of claim 1, wherein the verification data is included in the delivery payment coding using at least one of a bar code and a PLANET code.

5. The method of claim 1, wherein the delivery payment coding is included in an address label.

6. The method of claim 1, wherein the delivery payment coding includes a visual representation of a monetary value associated with the delivery payment coding.

7. The method of claim 1, wherein the item delivery system comprises the United States Postal Service.

8. The method of claim 1, wherein the item comprises at least one of a mailpiece, a United States Postal Service Priority Mail package, a United States Postal Service Express Mail Package, a United States Postal Service Global Express Mail Package, and a United States Postal Service Global Express Guarantee Package.

9. The method of claim 1, wherein transmitting the verification data further comprises utilizing at least one of regular mail, e-mail, facsimile, internet, and an interactive voice response system.

10. The method of claim 1, wherein providing the verification data further comprises communicating over a network.

11. The method of claim 1, wherein the verification data is provided in an encrypted format.

12. The method of claim 1, further comprising:
receiving a request for the verification data; and
receiving a payment for delivery of the item.

13. The method of claim 12, wherein at least one of receiving the request for the verification data and receiving the payment further comprises utilizing at least one of regular mail, e-mail, facsimile, internet, and an interactive voice response system.

14. The method of claim 12, wherein at least one of receiving the request for the verification data and receiving the payment further comprises communicating over a network.

15. The method of claim 12, wherein receiving the payment comprises at least one of sending a bill, debiting a checking account, debiting a credit card account, debiting a debit card account, and receiving cash.

16. The method of claim 1, further comprising:
delivering the item to a recipient; and
confirming the item delivery using the verification data from the delivery payment coding.

17. The method of claim 1, wherein verifying the authenticity of the delivery payment coding further comprises:
receiving the verification data from the delivery payment coding after the item has been received in the item delivery system;
comparing the verification data obtained from the delivery payment coding to a verification database; and
determining the validity of the verification data obtained from the delivery payment coding.

18. The method of claim 17, wherein verifying the authenticity of the delivery payment coding further comprises returning the item to a sender if it is determined that the verification data is invalid.

19. The method of claim 17, wherein verifying the authenticity of the delivery payment coding further comprises updating the verification database if it is determined that the verification data is valid, the update indicating that the verification data has been used.

20. The method of claim 17, wherein verifying the authenticity of the delivery payment coding further comprises updating the verification database if it is determined that the verification data is valid, the update indicating that the item is in route through the item delivery system to a recipient.

21. The method of claim 17, wherein the verification data is configured to be invalid after a period of time has passed after the verification data was provided.

22. The method of claim 1, wherein transmitting verification data further comprises providing the verification data to a user through a user device, the user device configured to produce the delivery payment coding including the verification data.

23. The method of claim 22, wherein the user device is located in at least one of a home, an office, a store, a retail center kiosk, and an office of an item delivery system operator.

24. A system for providing a verifiable delivery payment coding, comprising:
a component for transmitting verification data configured to be included in a delivery payment coding;
a component for receiving an item in an item delivery system, the item comprising the delivery payment coding including the verification data; and
a component for verifying the authenticity of the delivery payment coding using the verification data.

25. The system of claim 24, wherein the verification data included in the delivery payment coding is machine readable.

26. The system of claim 24, wherein the verification data included in the delivery payment coding is optically scanable.

27. The system of claim 24, wherein the verification data is included in the delivery payment coding using at least one of a bar code and a PLANET code.

28. The system of claim 24, wherein the delivery payment coding is included in an address label.

29. The system of claim 24, wherein the delivery payment coding includes a visual representation of a monetary value associated with the delivery payment coding.

30. The system of claim 24, wherein the item delivery system comprises the United States Postal Service.

31. The system of claim 24, wherein the item comprises at least one of a mailpiece, a United States Postal Service Priority Mail package, a United States Postal Service Express Mail Package, a United States Postal Service Global Express Mail Package, and a United States Postal Service Global Express Guarantee Package.

32. The system of claim 24, wherein the component for transmitting the verification data further configured for utilizing at least one of regular mail, e-mail, facsimile, internet, and an interactive voice response system.

33. The system of claim 24, wherein the component for transmitting the verification data is further configured for communicating over a network.

34. The system of claim 24, wherein the verification data is provided in an encrypted format.

35. The system of claim 24, further comprising:
a component for receiving a request for the verification data; and
a component for receiving a payment for delivery of the item.

36. The system of claim 35, wherein at least one of the component for receiving the request for the verification data and the component for receiving the payment is further configured for utilizing at least one of regular mail, e-mail, facsimile, internet, and an interactive voice response system.

37. The system of claim 35, wherein at least one of the component for receiving the request for the verification data and the component for receiving the payment is further configured for communicating over a network.

38. The system of claim 35, wherein the component for receiving the payment is further configured for utilizing at least one of sending a bill, debiting a checking account, debiting a credit card account, debiting a debit card account, and receiving cash.

39. The system of claim 24, further comprising:
a component for delivering the item to a recipient; and
a component for confirming the item delivery using the verification data from the delivery payment coding.

40. The system of claim 24, wherein the component for verifying the authenticity of the delivery payment coding is further configured for:
receiving the verification data from the delivery payment coding after the item has been received in the item delivery system;
comparing the verification data obtained from the delivery payment coding to a verification database; and
determining the validity of the verification data obtained from the delivery payment coding.

41. The system of claim 40, wherein the component for verifying the authenticity of the delivery payment coding is further configured for returning the item to a sender if it is determined that the verification data is invalid.

42. The system of claim 40, wherein the component for verifying the authenticity of the delivery payment coding updates the verification database if it is determined that the verification data is valid, the update indicating that the verification data has been used.

43. The system of claim 40, wherein the component for verifying the authenticity of the delivery payment coding updates the verification database if it is determined that the verification data is valid, the update indicating that the item is in route through the item delivery system to a recipient.

44. The system of claim 40, wherein the verification data is configured to be invalid after a period of time has passed after the verification data was provided.

45. The system of claim 24, wherein the component for transmitting verification data is further configured for providing the verification data to a user through a user device, the user device configured to produce the delivery payment coding including the verification data.

46. The system of claim 45, wherein the user device is located in at least one of a home, an office, a store, a retail center kiosk, and an office of an item delivery system operator.

47. A computer-readable medium on which is stored a set of instructions for providing a verifiable delivery payment coding, which when executed perform stages comprising:
transmitting verification data configured to be included in a delivery payment coding;
receiving an item in an item delivery system, the item comprising the delivery payment coding including the verification data; and
verifying the authenticity of the delivery payment coding using the verification data included in the delivery payment coding.

48. The computer-readable medium of claim 47, wherein the verification data included in the delivery payment coding is machine readable.

49. The computer-readable medium of claim 47, wherein the verification data included in the delivery payment coding is optically scanable.

50. The computer-readable medium of claim 47, wherein the verification data is included in the delivery payment coding using at least one of a bar code and a PLANET code.

51. The computer-readable medium of claim 47, wherein the delivery payment coding is included in an address label.

52. The computer-readable medium of claim 47, wherein the delivery payment coding includes a visual representation of a monetary value associated with the delivery payment coding.

53. The computer-readable medium of claim 47, wherein the item delivery system comprises the United States Postal Service.

54. The computer-readable medium of claim 47, wherein the item comprises at least one of a mailpiece, a United States Postal Service Priority Mail package, a United States Postal Service Express Mail Package, a United States Postal Service Global Express Mail Package, and a United States Postal Service Global Express Guarantee Package.

55. The computer-readable medium of claim 47, wherein transmitting the verification data further comprises utilizing at least one of regular mail, e-mail, facsimile, internet, and an interactive voice response system.

56. The computer-readable medium of claim 47, wherein providing the verification data further comprises communicating over a network.

57. The computer-readable medium of claim 47, wherein the verification data is provided in an encrypted format.

58. The computer-readable medium of claim 47, further comprising:
receiving a request for the verification data; and
receiving a payment for delivery of the item.

59. The computer-readable medium of claim 58, wherein at least one of receiving the request for the verification data and receiving the payment further comprises utilizing at least one of regular mail, e-mail, facsimile, internet, and an interactive voice response system.

60. The computer-readable medium of claim 58, wherein at least one of receiving the request for the verification data and receiving the payment further comprises communicating over a network.

61. The computer-readable medium of claim 58, wherein receiving the payment comprises at least one of sending a bill, debiting a checking account, debiting a credit card account, debiting a debit card account, and receiving cash.

62. The computer-readable medium of claim 47, further comprising: delivering the item to a recipient; and
confirming the item delivery using the verification data from the delivery payment coding.

63. The computer-readable medium of claim 47, wherein verifying the authenticity of the delivery payment coding further comprises:
receiving the verification data from the delivery payment coding after the item has been received in the item delivery system;
comparing the verification data obtained from the delivery payment coding to a verification database; and
determining the validity of the verification data obtained from the delivery payment coding.

64. The computer-readable medium of claim 63, wherein verifying the authenticity of the delivery payment coding further comprises returning the item to a sender if it is determined that the verification data is invalid.

65. The computer-readable medium of claim 63, wherein verifying the authenticity of the delivery payment coding further comprises updating the verification database if it is determined that the verification data is valid, the update indicating that the verification data has been used.

66. The computer-readable medium of claim 63, wherein verifying the authenticity of the delivery payment coding further comprises updating the verification database if it is determined that the verification data is valid, the update indicating that the item is in route through the item delivery system to a recipient.

67. The computer-readable medium of claim 63, wherein the verification data is configured to be invalid after a period of time has passed after the verification data was provided.

68. The computer-readable medium of claim 47, wherein transmitting verification data further comprises providing the verification data to a user through a user device, the user device configured to produce the delivery payment coding including the verification data.

69. The computer-readable medium of claim 68, wherein the user device is located in at least one of a home, an office, a store, a retail center kiosk, and an office of an item delivery system operator.

70. A system for providing a verifiable delivery payment coding, comprising:
a means for transmitting verification data configured to be included in a delivery payment coding;
a means for receiving an item in an item delivery system, the item comprising the delivery payment coding including the verification data; and
a means for verifying the authenticity of the delivery payment coding using the verification data included in the delivery payment coding.

71. The system of claim 70, wherein the verification data included in the delivery payment coding is machine readable.

72. The system of claim 70, wherein the verification data included in the delivery payment coding is optically scanable.

73. The system of claim 70, wherein the verification data is included in the delivery payment coding using at least one of a bar code and a PLANET code.

74. The system of claim 70, wherein the delivery payment coding is included in an address label.

75. The system of claim 70, wherein the delivery payment coding includes a visual representation of a monetary value associated with the delivery payment coding.

76. The system of claim 70, wherein the item delivery system comprises the United States Postal Service.

77. The system of claim 70, wherein the item comprises at least one of a mailpiece, a United States Postal Service Priority Mail package, a United States Postal Service Express Mail Package, a United States Postal Service Global Express Mail Package, and a United States Postal Service Global Express Guarantee Package.

78. The system of claim 70, wherein the means for transmitting the verification data further configured for utilizing at least one of regular mail, e-mail, facsimile, internet, and an interactive voice response system.

79. The system of claim 70, wherein the means for providing the verification data is further configured for communicating over a network.

80. The system of claim 70, wherein the verification data is provided in an encrypted format.

81. The system of claim 70, further comprising:
a means for receiving a request for the verification data; and
a means for receiving a payment for delivery of the item.

82. The system of claim 81, wherein at least one of the means for receiving the request for the verification data and the means for receiving the payment is further configured for utilizing at least one of regular mail, e-mail, facsimile, internet, and an interactive voice response system.

83. The system of claim 81, wherein at least one of the means for receiving the request for the verification data and the means for receiving the payment is further configured for communicating over a network.

84. The system of claim 81, wherein the means for receiving the payment is further configured for at least one of sending a bill, debiting a checking account, debiting a credit card account, debiting a debit card account, and receiving cash.

85. The system of claim 70, further comprising:
a means for delivering the item to a recipient; and
a means for confirming the item delivery using the verification data from the delivery payment coding.

86. The system of claim 70, wherein the means for verifying the authenticity of the delivery payment coding is further configured for:
receiving the verification data from the delivery payment coding after the item has been received in the item delivery system;
comparing the verification data obtained from the delivery payment coding to a verification database; and
determining the validity of the verification data obtained from the delivery payment coding.

87. The system of claim 86, wherein the means for verifying the authenticity of the delivery payment coding is further configured for returning the item to a sender if it is determined that the verification data is invalid.

88. The system of claim 86, wherein the means for verifying the authenticity of the delivery payment coding updates the verification database if it is determined that the verification data is valid, the update indicating that the verification data has been used.

89. The system of claim 86, wherein the means for verifying the authenticity of the delivery payment coding updates the verification database if it is determined that the verification data is valid, the update indicating that the item is in route through the item delivery system to a recipient.

90. The system of claim 86, wherein the verification data is configured to be invalid after a period of time has passed after the verification data was provided.

91. The system of claim 70, wherein the means for transmitting verification data is further configured for providing the verification data to a user through a user device, the user device configured to produce the delivery payment coding including the verification data.

92. The system of claim 91, wherein the user device is located in at least one of a home, an office, a store, a retail center kiosk, and an office of an item delivery system operator.
